(19) United States
(12) Patent Application Publication
(10) Pub. No.: US 2026/0173073 A1
(43) Pub. Date: Jun. 18, 2026

(54) SRS CONFIGURATION AND PRECODING INDICATION FOR SIMULTANEOUS MULTI-PANEL UPLINK TRANSMISSION

(71) Applicant: Apple Inc., Cupertino, CA (US)

(72) Inventors: Seyed Ali Akbar Fakoorian, San Diego, CA (US); Hong He, San Jose, CA (US); Dawei Zhang, Saratoga, CA (US); Chunxuan Ye, San Diego, CA (US); Wei Zeng, Saratoga, CA (US)

(21) Appl. No.: 19/126,038

(22) PCT Filed: Nov. 2, 2023
(86) PCT No.: PCT/US2023/078466

§ 371 Date: Apr. 30, 2025

Related U.S. Application Data
(60) Provisional application No. 63/422,881, filed on Nov. 4, 2022.

(51) Int. Cl. H04W 72/1268; H04L 5/00

(52) U.S. Cl. CPC H04W 72/1268; H04L 5/0048

(57) ABSTRACT

One or more processors execute instructions to cause a UE to perform operations. The operations include receiving a signal configuring the UE to simultaneously perform a first PUSCH transmission with a first TRP using a first antenna panel and a second PUSCH transmission with a second TRP using a second antenna panel. The operations include determining, based on a higher layer parameter, that the UE is configured with non-codebook based precoding. The operations include determining, based on the signal, a first SRS resource set for the first PUSCH transmission and a second SRS resource set for the second PUSCH transmission. The operations include determining, based on the signal, a first number of SRS resources in the first SRS resource set and a second number of SRS resources in the second SRS resource set. The operations include causing the UE to transmit one or more SRSs to each TRP.

### CLAIM OF PRIORITY

The present application claims priority to U.S. Provisional Patent Application No. 63/422,881, filed on Nov. 4, 2022, entitled “SRS CONFIGURATION AND PRECODING INDICATION FOR SIMULTANEOUS MULTI-PANEL UPLINK TRANSMISSION,” which is herein incorporated by reference in its entirety.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with one aspect of the present disclosure, one or more processors have circuitry that executes instructions to cause a UE to perform operations. The operations include receiving, from a base station, a signal that configures the UE to simultaneously perform a first PUSCH transmission with a first TRP using a first antenna panel and a second PUSCH transmission with a second TRP using a second antenna panel. The operations include determining, based on a higher layer parameter, that the UE is configured with non-codebook based precoding. The operations include determining, based on the signal, a first sounding reference signal (SRS) resource set for the first PUSCH transmission and a second SRS resource set for the second PUSCH transmission. The operations include determining, based on the signal, (i) a first number of SRS resources in the first SRS resource set and (ii) a second number of SRS resources in the second SRS resource set. The operations include causing the UE to transmit one or more first SRSs on the first number of SRS resources to the first TRP and one or more second SRSs on the second number of SRS resources to the second TRP.

In some implementations, the first number of SRS resources equals the second number of SRS resources.

In some implementations, the operations further include determining a first number of SRS ports associated with the SRS resources in first SRS resource set and determining a second number of SRS ports associated with the SRS resources in second SRS resource set.

In some implementations, the first number of SRS ports is different from the second number of SRS ports.

In some implementations, the operations further include determining a first number of bits of a transmit precoding matrix indicator (TPMI) for the first PUSCH transmission, determining a second number of bits of a TPMI for the second PUSCH transmission, and determining a third number of bits of a TPMI to be used when the UE switches to a PUSCH transmission with only one of the first TRP or the second TRP.

In some implementations, the first number of bits is determined based on the first number of SRS ports and a first maximum number of layers associated with the first SRS resource set, and the second number of bits is determined based on the second number of SRS ports and a second maximum number of layers associated with the second SRS resource set.

In some implementations, the third number of bits is determined based on a third maximum number of layers to be used when the UE switches to the PUSCH transmission with the only one of the first TRP or the second TRP.

In some implementations, the first number of bits, the second number of bits, and the third number of bits are determined based on one or more higher layer parameters.

In some implementations, the UE performs the first PUSCH transmission and the second PUSCH transmission using a space division multiplexing (SDM) scheme.

In accordance with one aspect of the present disclosure, a base station in communication with a UE has one or more processors coupled to a transceiver. The one or more processors are configured to determine one or more parameters that configure the UE to simultaneously perform a first PUSCH transmission with a first TRP using a first antenna panel and a second PUSCH transmission with a second TRP using a second antenna, the one or more parameters indicating a first SRS resource set for the first PUSCH transmission and a second SRS resource set for the second PUSCH transmission. The one or more processors are configured to determine a higher layer parameter. The transceiver is configured to transmit a signal with the one or more parameters to the UE, wherein the signal comprises information for the UE to determine (i) a first number of SRS resources in the first SRS resource set and (ii) a second number of SRS resources in the second SRS resource set. The transceiver is configured to transmit the higher layer parameter to configure the UE with non-codebook based precoding.

In some implementations, the first number of SRS resources equals the second number of SRS resources.

In some implementations, the signal further includes information for the UE to determine a first number of SRS ports associated with the SRS resources in first SRS resource set and a second number of SRS ports associated with the SRS resources in second SRS resource set.

In some implementations, the first number of SRS ports is different from the second number of SRS ports.

In some implementations, the one or more processors are configured to determine at least one of (iii) a first TPMI for the first PUSCH transmission, (iv) a second TPMI for the second PUSCH transmission, or (v) a third TPMI to be used when the UE switches to a PUSCH transmission with only one of the first TRP or the second TRP. The transceiver is configured to transmit downlink control information (DCI) to the UE, the DCI comprising the at least one of the first TMPI, the second TPMI, or the third TPMI

In accordance with one aspect of the present disclosure, a method includes receiving, from a base station, a signal that configures a UE to simultaneously perform a first PUSCH transmission with a first TRP using a first antenna panel and a second PUSCH transmission with a second TRP using a second antenna panel. The method includes determining, based on a higher layer parameter, that the UE is configured with non-codebook based precoding. The method includes determining, based on the signal, a first SRS resource set for the first PUSCH transmission and a second SRS resource set for the second PUSCH transmission. The method includes determining, based on the signal, (i) a first number of SRS resources in the first SRS resource set and (ii) a second number of SRS resources in the second SRS resource set. The method includes transmitting one or more first SRSs on the first number of SRS resources to the first TRP and one or more second SRSs on the second number of SRS resources to the second TRP.

In some implementations, the first number of SRS resources equals the second number of SRS resources.

In some implementations, the method includes determining a first number of SRS ports associated with the SRS resources in first SRS resource set and determining a second number of SRS ports associated with the SRS resources in second SRS resource set.

In some implementations, the first number of SRS ports is different from the second number of SRS ports.

In some implementations, the method includes determining a first number of bits of a TPMI for the first PUSCH transmission, determining a second number of bits of a TPMI for the second PUSCH transmission, and determining a third number of bits of a TPMI to be used when the UE switches to a PUSCH transmission with only one of the first TRP or the second TRP.

In some implementations, the UE performs the first PUSCH transmission and the second PUSCH transmission using an SDM scheme.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2 illustrates an example procedure in which a base station configures a UE for PUSCH transmission, according to some implementations.

FIG. 3 illustrates two tables that a UE refers to for determining the number of bits of one or more SRI, according to some implementations.

FIGS. 4A-4H each illustrate a table that a UE refers to for determining the number of bits of one or more TPMI, according to some implementations.

FIG. 5A illustrates a flowchart of an example method, according to some implementations.

FIG. 5B illustrates a flowchart of another example method, according to some implementations.

FIG. 6 illustrates a UE, according to some implementations.

FIG. 7 illustrates an access node, according to some implementations.

### DETAILED DESCRIPTION

Some wireless communication networks support multiple transmission/reception point (TRP) (multi-TRP or m-TRP) operation. In these networks, one or more base stations may act as or otherwise utilize multiple TRPs to communicate with a user equipment (UE). To facilitate multi-TRP operation, the TRPs and the UE can each include multiple antenna panels. A UE that includes multiple antenna panels is referred to as a multi-panel UE. A UE can utilize its antenna panel(s) to transmit uplink signals in channels such as physical uplink shared channel (PUSCH). Before transmitting data in PUSCH, the UE can precode the data by multiplying the data with a precoding matrix. The precoding matrix can be determined with or without a codebook. Whether the UE performs codebook-based precoding or non-codebook-based precoding can be configured according to a higher layer parameter, such as txConfig.

To prepare for PUSCH transmission, a UE often transmits one or more SRSs using configured SRS resources to the base station. The base station configures the SRS resources in one or more SRS resource sets, e.g., one set for each panel of the UE. The number of SRS resources in each SRS resource set may or may not be the same, and may vary between codebook-based precoding and non-codebook-based precoding. Additionally, the number of antenna ports corresponding to each SRS resource (SRS ports) may or may not be the same, and may vary between codebook-based precoding and non-codebook-based precoding. For example, a UE configured to perform codebook-based precoding can obtain the number of SRS ports from a higher layer parameter (e.g., nrofSRS-Ports) for each SRS resource, while a UE configured to perform non-codebook-based precoding can have only one SRS port for each SRS resource. The base station can transmit the parameter nrofSRS-Ports to the UE along with the configuration of the SRS resources.

Upon receipt of the SRS(s) from the UE, the base station selects one or more SRS resources and transmits an SRI corresponding to each configured resource set to the UE to inform the UE of the selected resource(s) for PUSCH transmission. In addition, the base station can determine various settings relating to uplink precoding and can indicate the precoding settings to the UE. These precoding indications may vary between codebook-based precoding and non-codebook-based precoding. For example, a UE configured to perform codebook-based precoding can obtain a precoding matrix and/or a parameter indicating a number of transmission layers from a transmit precoding matrix indicator (TPMI) for each configured resource set. The base station transmits the SRI and the TPMI to the UE via DCI.

Some UEs support simultaneous PUSCH transmissions to multiple TRPs using multiple panels. For example, a UE can be configured, e.g., by a DCI signal, to simultaneously transmit, via two panels, uplink signals in an SDM scheme to two TRPs. In some implementations with this feature, the UE can be configured with two SRS resource sets, one for each panel, as indicated by the base station (e.g., the two TRPs) in two SRIs. To reduce uncertainties and possible conflicts resulting from inconsistent and/or incompatible configurations implemented by different manufacturers, it is desirable to have an approach adopted both by the UE and the base station when performing SRS configuration and related operations to prepare for precoding in an m-TRP context. Furthermore, some UEs support dynamically switching from the m-TRP operation to a single-TRP operation (e.g., PUSCH transmission to a single TRP using one or more panels of the UE). It is thus also desirable that the base station and the UE, when performing SRS resource configurations and related operations, support dynamic switching of the UE from m-TRP operation to single-TRP operation.

This disclosure describes systems and methods that provide solutions to the described deficiencies in existing systems. As described in detail below, implementations of this disclosure provide an approach that can be adopted by both the UE and the base station to indicate SRS resource configurations and precoding settings while supporting dynamic switching from m-TRP operation to single-TPR operation. For both codebook-based precoding and non-codebook-based precoding, the implementations include features that are applicable in scenarios where the multiple SRS resource sets have different numbers of SRS resources. For codebook-based precoding, the implementations include features that are applicable where the SRS resources in the multiple SRS resource sets have different numbers of SRS ports nrofSRS-Ports. In addition, the implementations include features relating to configuring and indicating the maximum rank (number of transmission layers) for each panel and for all panels when the UE performs m-TRP operation or switches from m-TRP to single-TRP operation. Moreover, as the SRI and TPMI are transmitted via DCI, the implementations are particularly designed for reducing DCI overhead. According to some features, the UE can accurately locate the SRI and TPMI bits in the DCI and process these parameters for both m-TRP operation and single-TRP operation.

Among other benefits, implementations of this disclosure can improve the reliability, flexibility, and efficiency of communication between the UE and the base station, particularly when the UE uses multiple panels to perform simultaneous PUSCH transmissions with multiple TRPs. In the description below, it is assumed the UE uses two panels to communicate with two TRPs using. However, other numbers of panels and TRPs are possible and are contemplated herein.

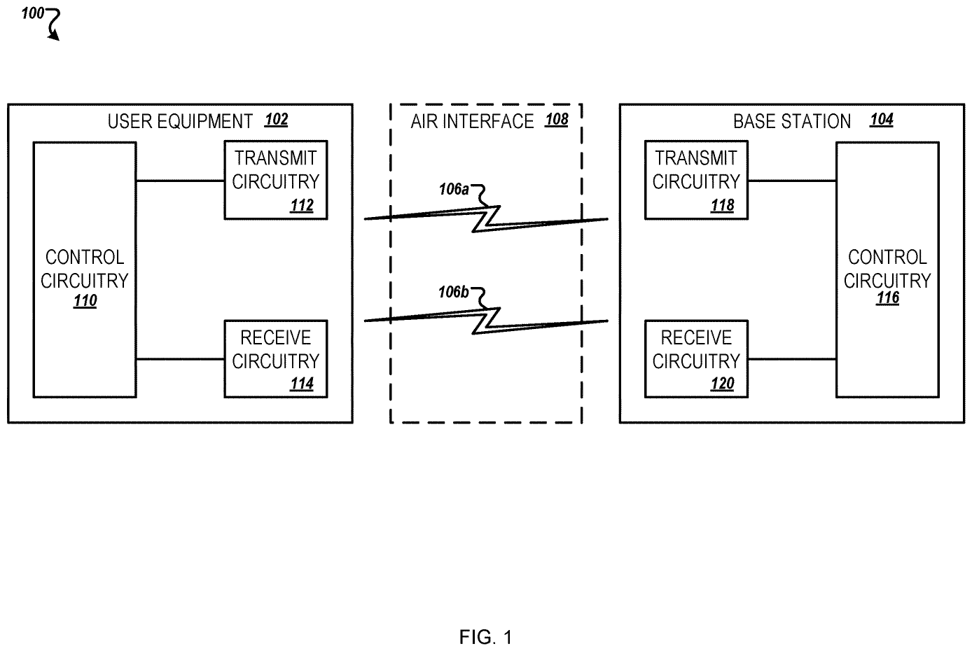

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can control the transmit circuitry 112 and the receive circuitry 114 to receive higher layer signals, transmit SRS signals, and receive DCI. The control circuitry 110 can also precode data for PUSCH transmission.

Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

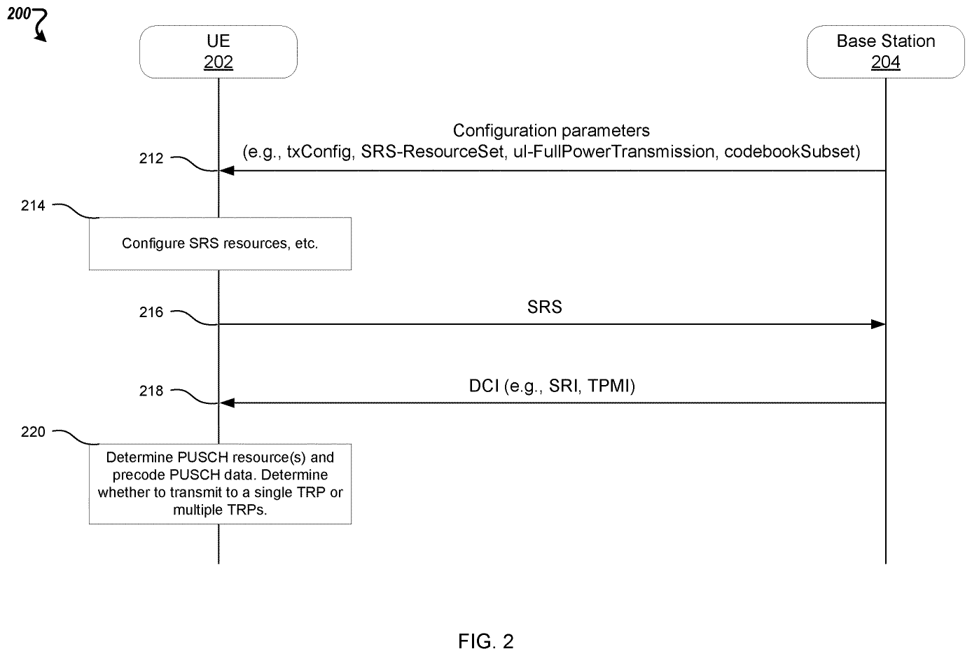

FIG. 2 illustrates an example procedure 200 in which base station 204 configures UE 202 for PUSCH transmission, according to some implementations. Procedure 200 can take place in, e.g., wireless network 100, and UE 202 and base station 204 can be similar to UE 102 and base station 104, respectively. In some implementations, UE 202 is configured to perform the PUSCH transmission using the SDM scheme.

At 212, base station 204 transmits configuration parameters, such as txConfig, SRS-ResourceSet, ul-FullPowerTransmission, and codebookSubset, to UE 202. The configuration parameters configure UE 202 for the upcoming PUSCH transmission. In some implementations, the configuration parameters are transmitted in one or more higher layer signals.

At 214, UE 202 configures SRS resources based on one or more of the configuration parameters. For example, UE 202 can determine whether PUSCH precoding is codebook-based or non-codebook-based from txConfig. According to the settings txConfig and FullPowerTransmission, UE 202 can configure one or more SRS resource sets, each having one or more SRS resources, based on the indication in SRS-ResourceSet. In particular, in m-TRP operation where UE 202 simultaneously performs two PUSCH transmissions to two TRPs using two antenna panels, base station 204 can indicate two SRS resource sets in two instances of SRS-ResourceSet. UE 202 can configure the two SRS resource sets, one for each panel, accordingly. The two SRS resource sets can each have the same number or different numbers of SRS resources, denoted as N_{1,SRS} and N_{2,SRS}, depending on a “usage” field of SRS-ResourceSet set by base station 204.

In some implementations, when base station 204 sets the “usage” field to “nonCodebook,” UE 202 supports SRS resource configurations in which two SRS resource sets have the same or different numbers of SRS resources. That is, when base station 204 sets the “usage” field to “nonCodebook,” UE 202 supports configuring N_{1,SRS} and N_{2,SRS} to be the same (e.g., both equal to 2) or different (e.g., equal to 4 and 2, respectively). The support for N_{1,SRS} being different from N_{2,SRS} may have certain exceptions based on numbers of transmission layers configured, as described later.

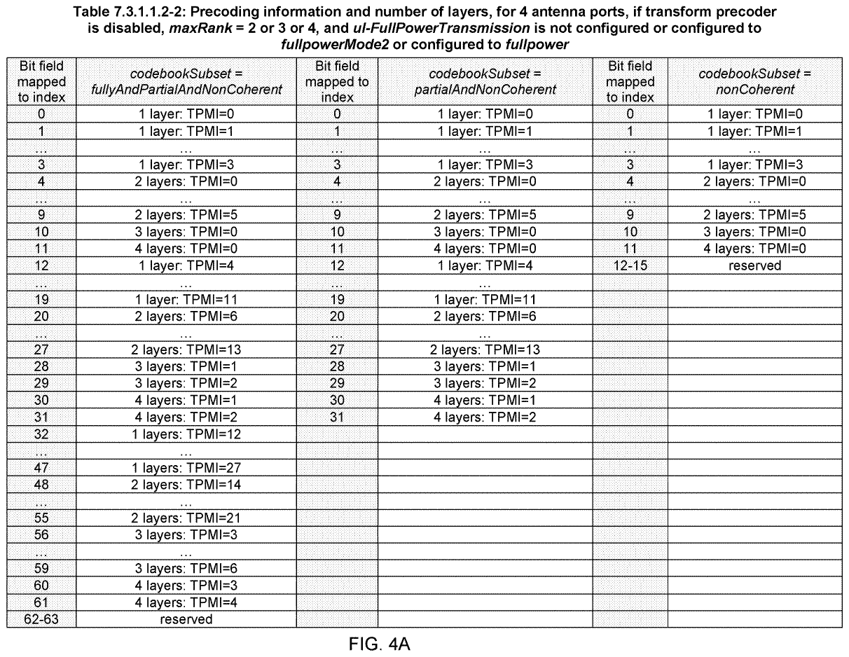

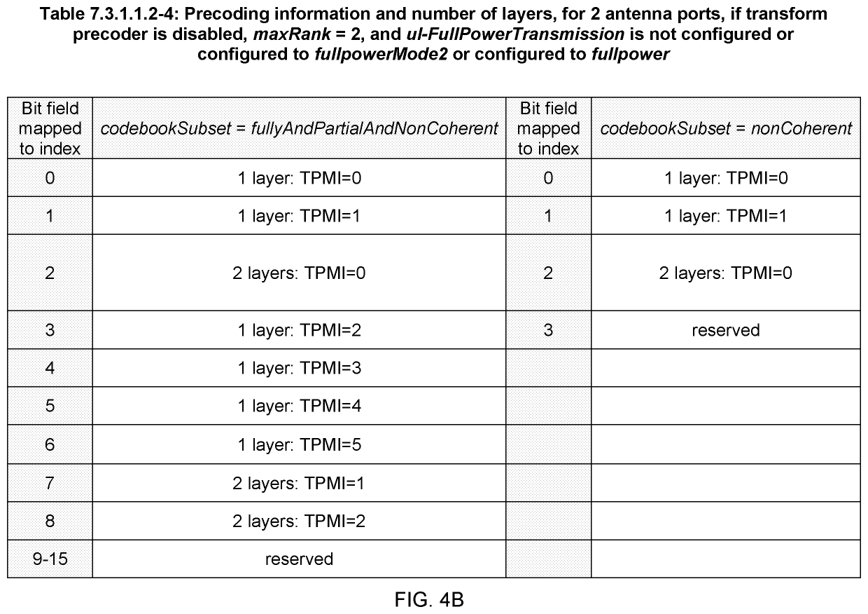

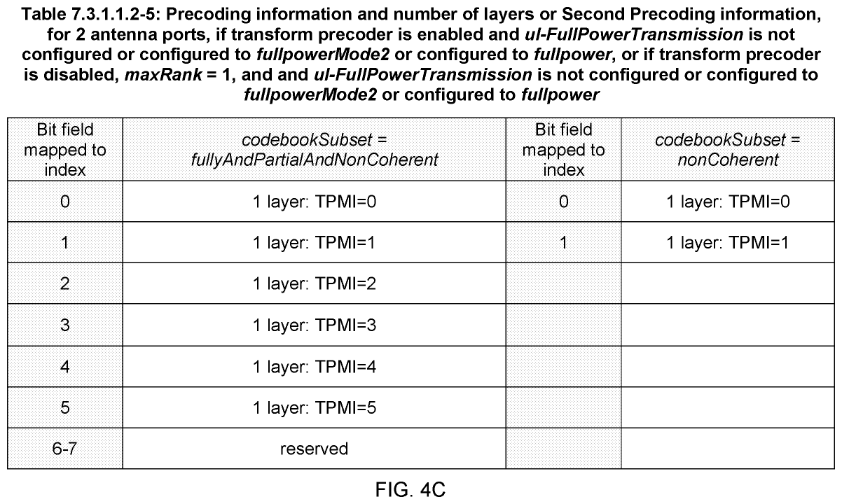

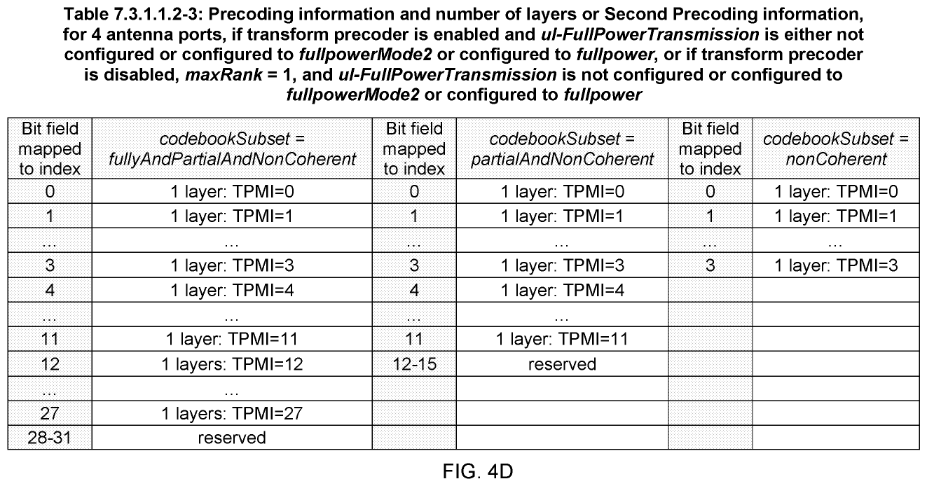

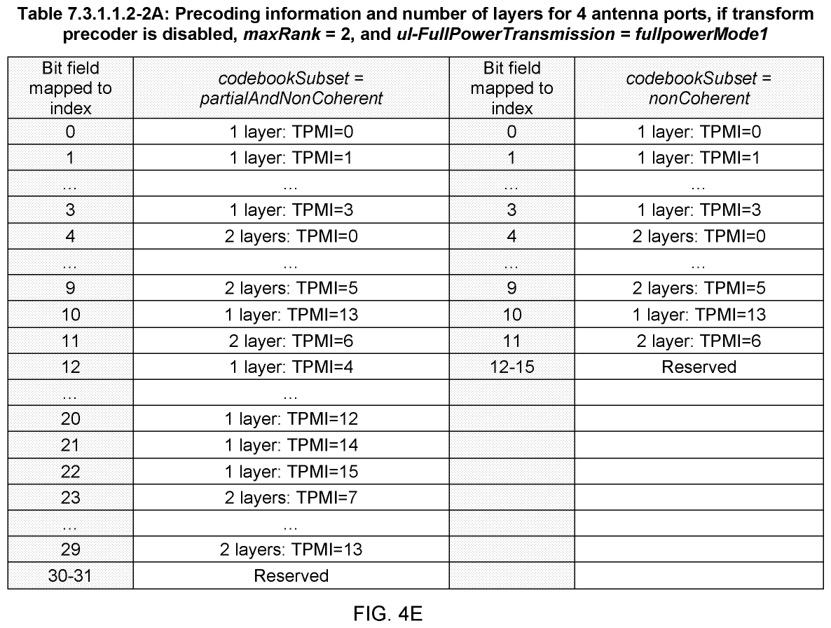

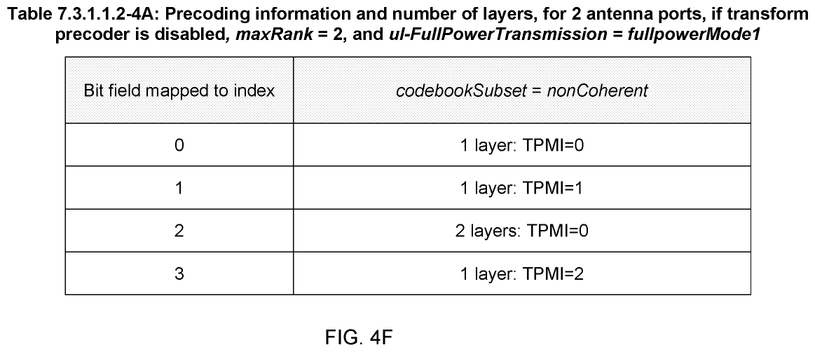

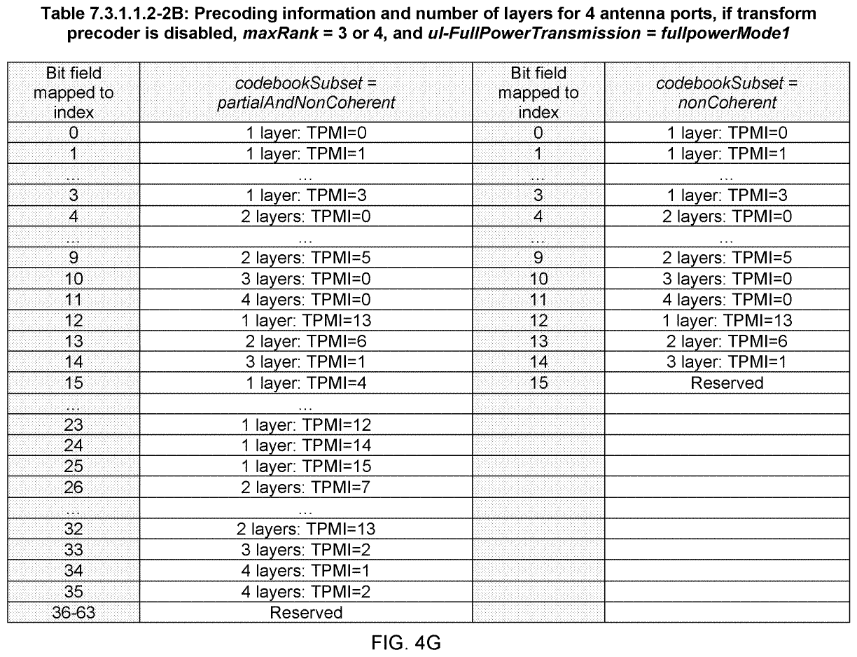

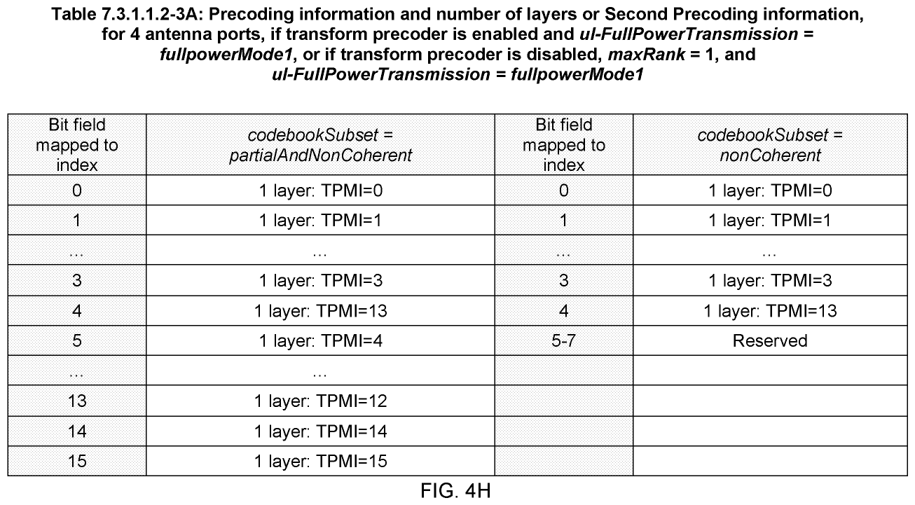

In some implementations, when base station 204 sets the “usage” field to “Codebook,” UE 202 only supports SRS resource configurations in which two SRS resource sets have the same number of SRS resources. That is, when base station 204 sets the “usage” field to “Codebook,” UE 202 supports configuring N_{1,SRS} and N_{2,SRS} to be the same (both 2) only. In some alternative implementations, when base station 204 sets the “usage” field to “Codebook,” UE 202 supports SRS resource configurations in which two SRS resource sets have the same (e.g., both 2) or different (e.g., 4 and 2) numbers of SRS resources. In these alternative implementations, when base station 204 sets the “usage” field to “Codebook,” UE 202 can also support SRS port configurations in which the two SRS resource sets are associated with the same (e.g., 2) or different (e.g., 4 and 2, respectively) numbers of SRS ports, nrofSRS-Ports, for the resources within each set. For example, when nrofSRS-Ports equals 2 for both SRS resource sets, all SRS resources in the first SRS resource set are configured with 2 SRS ports, and all SRS resources in the second SRS resource set are also configured with 2 SRS ports. Also, when nrofSRS-Ports equals 2 for the first SRS resource set and equals 4 for the second SRS resource set, all SRS resources in the first SRS resource set are configured with 2 SRS ports, and all SRS resources in the second SRS resource set are also configured with 4 SRS ports. UE 202 can use the two numbers of nrofSRS-Ports, whether the same or different, to determine two TPMI bit-fields associated with the two SRS resource sets for m-TRP operation, and can determine a TPMI bit-field associated with the SRS resource set in case of dynamically switching to single-TRP operation. As explained below with reference to FIGS. 4A-4H, the features of these alternative implementations can reduce DCI overhead because the size of the TPMI bit-field for single-TRP is no greater than the sum of sizes of TPMI bit-fields for m-TRP.

In addition to configuring SRS resources, base station 204 can configure the maximum number of layers, maxRank, used by UE 202 for the PUSCH transmission. To support m-TRP operation and dynamic switching from m-TRP to single-TRP, base station 204 can indicate one or more parameters to account for multiple PUSCH transmissions. These one or more parameters can be transmitted by higher layer signaling, such as one or more higher layer signals at 212.

In some implementations, base station 204 indicates a combination of three numbers as maxRank indication: (L_{Smax}, L_{1,Mmax}, L_{2,Mmax}). L_{Smax} represents the maximum number of layers when UE 202 is indicated to switch from m-TRP to single TRP operation. L_{1,Mmax} and L_{2,Mmax} represent the maximum numbers of layers respectively associated with the two SRS resource sets when UE 202 is indicated to perform simultaneous m-TRP operation. For instance, when base station 204 indicates (4, 2, 2) to UE 202, UE 202 can configure up to 2 layers for each SRS resource set to perform simultaneous m-TRP PUSCH transmission, and can configure up to 4 layers for the SRS resource when switching to perform single TRP PUSCH transmission. Before or after the indication of (L_{Smax}, L_{1,Mmax}, L_{2,Mmax}), UE 202 can inform base station 204 of UE 202's capability to support maxRank configurations. For example, UE 202 can inform that it is capable to support only combinations where (a) L_{Smax}≥L_{1,Mmax}+L_{2,Mmax}, (b) L_{Smax}≥L_{1,Mmax} and L_{Smax}≥L_{2,Mmax}, or (c) L_{Smax}<L_{1,Mmax}+L_{2,Mmax}. Accordingly, if UE 202 is capable for (a) only but base station 204 configures maxRank with a combination of (3, 2, 2), then UE 202 finds the combination invalid. UE 202 can discard the invalid combination and request another maxRank configuration.

In some implementations, base station 204 indicates a combination of four numbers as maxRank indication: (L_{1,Smax}, L_{2,Smax}, L_{1,Mmax}, L_{2,Mmax}). Different from the three-number combination, even for single TRP operation, each panel is indicated its own maximum number of layers.

In some implementations, base station 204 indicates a single number L_{Smax} for both m-TRP and single TRP operations. While this format of maxRank indication is simpler than the formats with three-number combination and four-number combination, UE 202 may require DCI to provide more fields in order to understand the selection made by base station 204 at 218. In other words, this single-number format of maxRank indication may require higher DCI overhead.

As stated previously, when base station 204 sets the “usage” field to “nonCodebook,” UE 202 supports SRS resource configurations in which N_{1,SRS} and N_{2,SRS} are the same or different, with certain exceptions based on numbers of transmission layers. In some implementations where maxRank indication is formatted with the three-number combination (L_{Smax}, L_{1,Mmax}, L_{2,Mmax}), the exceptions can include three example cases.

As a first case of exception, when L_{1,Mmax} and L_{2,Mmax} both equal 1 and L_{Smax} equals 2, 3, or 4, the following combinations of (N_{1,SRS}, N_{2,SRS}) are excluded from the SRS resource configurations supported by UE 202: (2, 4) and (4, 2).

As a second case of exception, when L_{1,Mmax} equals 1, L_{2,Mmax} equals 1, 2, 3, or 4, and L_{Smax} equals 2, 3, or 4, the following combinations of (N_{1,SRS}, N_{2,SRS}) are excluded from the SRS resource configurations supported by UE 202: (1, 2), (1, 3), and (1, 4).

As a third case of exception, when L_{2Mmax} equals 1, L_{1,Mmax} equals 1, 2, 3, or 4, and L_{Smax} equals 2, 3, or 4, the following combinations of (N_{1,SRS}, N_{2,SRS}) are excluded from the SRS resource configurations supported by UE 202: (2, 1), (3, 1), and (4, 1).

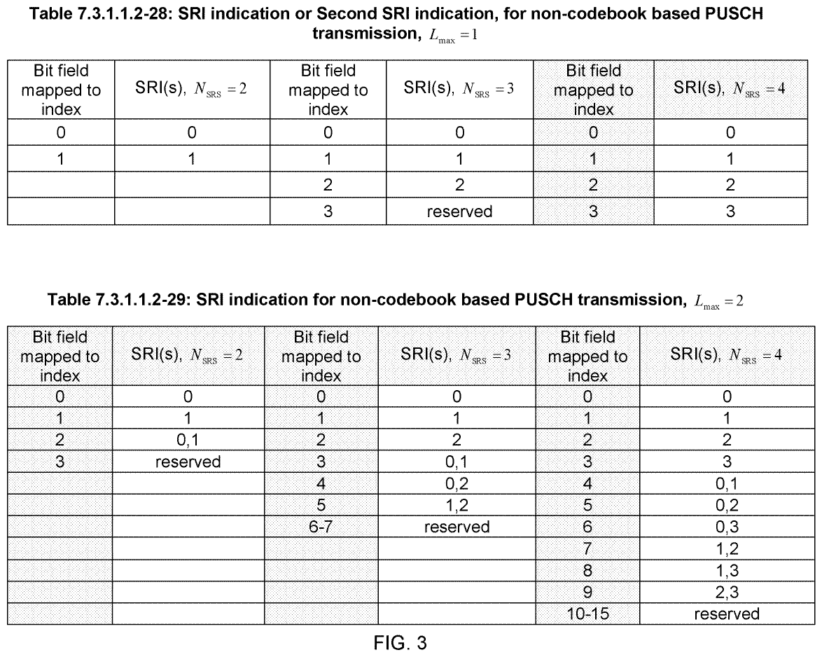

With (N_{1,SRS}, N_{2,SRS}) and (L_{Smax}, L_{1,Mmax}, L_{2,Mmax}) configured, UE 202 can use the combinations of (L_{1,Mmax}, N_{1,SRS}) and (L_{2,Mmax}, N_{2,SRS}) to determine two SRI bit-fields associated with the two SRS resource sets for m-TRP operation, and can determine an SRI bit-field associated with the SRS resource set in case of dynamically switching to single-TRP operation. As explained below with reference to FIG. 3, the features described herein can reduce DCI overhead because the size of the SRI bit-field for single-TRP is no greater than the sum of sizes of SRI bit-fields for m-TRP.

Keeping with FIG. 2, at 216, UE 202 transmits one or more SRSs to base station 204 using the configured SRS resources. In m-TRP operation, UE 202 transmits one set of SRSs to each TRP using SRS resources in the corresponding SRS resource set. Based on the received SRSs, base station 204 can select one SRS resource that is most suitable for PUSCH transmission (e.g., having the best quality) to each TRP.

At 218, base station 204 transmits DCI to UE 202. Within the DCI, base station 204 can indicate which SRS resource set(s) UE 202 should use for PUSCH transmission. If 2 SRS resource sets are indicated, then UE 202 should perform m-TRP operation using the two indicated SRS resource sets. Conversely, if only one SRS resource set is indicated by the DCI, then UE 202 should switch from m-TRP operation to single-TRP operation. Additionally, base station 204 can include within the DCI an SRI to indicate UE 202 of the selected SRS resource for each TRP. For non-codebook based precoding, base station 204 can also include within DCI a TPMI that indicates precoding information and/or the number of layers conveyed over the SRS ports associated with the configured SRS resource in each set.

At 220, UE 202 precodes PUSCH data according to the configurations and the indications from base station 204. For example, UE 202 can determine, by decoding SRI, the resource selected by base station 204 for PUSCH transmission to each TRP, and determine, by decoding TPMI, the precoding matrices for precoding PUSCH data to be transmitted to each TRP. In addition, in the event UE 202 detects only one SRS resource set in the DCI, UE 202 understands it is configured to dynamically switch to single-TRP operation. To perform the switch, UE 202 decodes TPMI and looks for the bit fields corresponding to single-TRP precoding.

FIG. 3 illustrates two tables that a UE (e.g., UE 102 of FIG. 1 or UE 202 of FIG. 2) refers to for determining the number of bits of one or more SRI, according to some implementations where the “usage” field of SRS-ResourceSet is set to “nonCodebook.” The two tables, numbered 7.3.1.1.2-28 and 7.3.1.1.2-29, can be the same as those similarly numbered in Release 16 of 3GPP TS 38.212, e.g., TS 38.212 V16.10.0 (TS 38.212), which is incorporated in this application by reference. An example combination of (L_{Smax}, L_{1,Mmax}, L_{2,Mmax}) being (2, 1, 1) is used to illustrate the determination of number SRI bits. Tables 7.3.1.1.2-30 and 7.3.1.1.2-31 in TS 38.212 can be similarly referred to for combinations with any of the three numbers being different from 1 and 2. The examples described below include single-TRP scenarios where the number SRS resources of the indicated SRS resource set, N_{SRS}, respectively equals 1, 2, 3, and 4, and also include m-TRP scenarios where the number SRS resources of one of the indicated SRS resource sets, N_{SRS, 1} or N_{SRS, 2}, respectively equals 1, 2, 3, and 4.

For single-TRP operation, because L_{Smax} equals 2, table 7.3.1.1.2-29 is used. For a scenario where N_{SRS}=2, the left two columns provide 4 rows, each mapping a bit field to an index. Two binary bits are needed to cover four bit fields. Therefore, the number of SRI bits needed for s-TRP is two when N_{SRS}=2. Similarly, for a scenario where N_{SRS}=3, the middle two columns provide eight rows, each mapping a bit field to an index. Three binary bits are needed to cover eight bit fields. Therefore, the number of SRI bits needed for s-TRP is three when N_{SRS}=2. Likewise, for a scenario where N_{SRS}=3, the right two columns indicate that 4 bits are needed to cover 16 bit fields. Therefore, the number of SRI bits needed for s-TRP is 4 when N_{SRS}=3. Because the table does not provide columns for N_{SRS}=1, the corresponding number of needed SRI bits can be considered as 0. Thus, the number of SRI bits needed for s-TRP is 0, 2, 3, and 4 for scenarios where N_{SRS} equals 1, 2, 3, and 4, respectively.

For m-TRP operation, because L_{1,Mmax} and L_{2,Mmax} both equal 2, table 7.3.1.1.2-30 is used. The corresponding number of SRI bits can thus be determined as 1, 2, and 2, for scenarios where N_{SRS, 1} (or N_{SRS, 2}) equals 2, 3, and 4, respectively. Because the table does not provide columns for N_{SRS}=1, the corresponding number of needed SRI bits can be considered as 0. Adding the SRI bits for both SRS resource sets, the total number of SRI bits across the two SRS resource sets for m-TRP operation is 0, 2, 4, and 4 for scenarios where N_{SRS, 1} and N_{SRS, 2} both equal 1, 2, 3, and 4, respectively. It can be seen that for each scenario, the total number of SRI bits for m-TRP operation is always greater than or equal to the number of SRI bits for s-TRP operation. Thus, base station 204 does not need to provide extra DCI bits for SRI when instructing UE 202 to dynamically switch from m-TRP to single-TRP. This can simplify DCI structure and avoid significantly increasing DCI overhead.

FIGS. 4A-4H each illustrate a table that a UE (e.g., UE 102 of FIG. 1 or UE 202 of FIG. 2) refers to for determining the number of bits of one or more TPMI in various scenarios, according to some implementations. These tables can be the same as those similarly numbered in TS 38.212. The UE refers to the illustrated tables based on higher layer configurations such as the setting of codebookSubset, the maxRank indication (L_{Smax}, L_{1,Mmax}, L_{2,Mmax}), and the number of SRS ports, N_{1,ant} and N_{2,ant}, corresponding to the SRS resource sets. Other tables in TS 38.212 can be used for scenarios with other settings.

A first example scenario assumes parameter codebookSubset is set to a value of “fullyAndPartialAndNonCoherent,” ul-FullPowerTransmission is not configured, (L_{Smax}, L_{1,Mmax}, L_{2,Mmax})=(4, 2, 2), and (N_{1,ant}, N_{2,ant})=(4, 2). For m-TRP operation, as the first SRS resource set has L_{1,Mmax}=2 maximum transmission layers and N_{1,ant}=4 SRS ports, table 7.3.1.1.2-2 in FIG. 4A applies. From the left two columns corresponding to codebookSubset=fullyAndPartialAndNonCoherent, it can be seen there are 64 bit fields, which need 8 binary bits. Therefore, the UE can determine that the TPMI corresponding to the first SRS resource set is indicated using 6 bits in DCI. Similarly, as the second SRS resource set has L_{2,Mmax}=2 maximum transmission layers and N_{2,ant}=2 SRS ports, table 7.3.1.1.2-4 in FIG. 4B applies. From the left two columns, it can be seen there are 16 bit fields, which need 4 binary bits. Therefore, the UE can determine that the TPMI corresponding to the second SRS resource set is indicated using 4 bits in DCI. The total number of bits for TPMI is thus 10 bits in DCI.

Continuing with the first example scenario, for single TRP operation, as the SRS resource set has L_{Smax}=4 maximum transmission layers, table 7.3.1.1.2-2 in FIG. 4A applies. From FIG. 4A the UE can determine that 6 DCI bits are needed for TPMI in single-TRP operation. Consistent with this determination, the UE and the base station can agree that the first 6 bits of the 10 TPMI bits are used as TPMI when the base station instructs the UE to switch from m-TRP to single-TRP operation.

A second example scenario assumes parameter codebookSubset is set to a value of “fullyAndPartialAndNonCoherent,” ul-FullPowerTransmission is not configured, (L_{Smax}, L_{1,Mmax}, L_{2,Mmax})=(4, 2, 1), and (N_{1,ant}, N_{2,ant})=(4, 2). For m-TRP operation, as the first SRS resource set has L_{1,Mmax}=2 maximum transmission layers and N_{1,ant}=4 SRS ports, table 7.3.1.1.2-2 in FIG. 4A again applies. Similar to the first example scenario, the UE can determine that the TPMI corresponding to the first SRS resource set is indicated using 6 bits in DCI. As the second SRS resource set has L_{2,Mmax}=1 maximum transmission layer and N_{2,ant}=2 SRS ports, table 7.3.1.1.2-5 in FIG. 4C applies. From the two left columns, the UE can determine that the TPMI corresponding to the second SRS resource set is indicated using 3 bits in DCI. The total number of bits for TPMI is thus 9 bits for m-TRP operation.

Continuing with the second example scenario, for single TRP operation, as the SRS resource set has L_{Smax}=4 maximum transmission layers, table 7.3.1.1.2-2 in FIG. 4A again applies. From the table, the UE can determine that 6 DCI bits are needed for TPMI for single-TRP operation. Consistent with this determination, the UE and the base station can agree that the first 6 bits of the 9 TPMI bits are used as TPMI when the base station instructs the UE to switch from m-TRP to single-TRP operation.

A third example scenario assumes parameter codebookSubset is set to a value of “nonCoherent,” ul-FullPowerTransmission is not configured, (L_{Smax}, L_{1,Mmax}, L_{2,Mmax})=(2 or 3 or 4, 1, 1), and (N_{1,ant}, N_{2,ant})=(4, 2). This scenario corresponds to the first case of exception, described above, from the SRS resource configurations. The reason for excluding this scenario can be understood with the below discussion.

Following a similar approach to the first and the second example scenarios, for m-TRP operation, as the first SRS resource set has L_{1,Mmax}=1 maximum transmission layer and N_{1,ant}=4 SRS ports, table 7.3.1.1.2-3 in FIG. 4D applies. From the right two columns of table, the UE can determine that the TPMI corresponding to the first SRS resource set is indicated using 2 bits in DCI. Likewise, as the second SRS resource set has L_{2,Mmax}=1 maximum transmission layer and N_{2,ant}=2 SRS ports, table 7.3.1.1.2-5 in FIG. 4C applies. From the right two columns of the table, the UE can determine that the TPMI corresponding to the second SRS resource set is indicated using 1 bit in DCI. The total number is 3 bits of DCI for TPMI for m-TRP operation.

For single-TRP operation, as the SRS resource set has L_{Smax}=2, 3, or 4, maximum transmission layers, table 7.3.1.1.2-2 in FIG. 4A again applies. From the right two columns of table, the UE can determine that the TPMI now needs 4 DCI bits for single-TRP operation, exceeding the 3 bits for m-TRP operation. If the UE and the base station do not exclude this scenario from SRS resource configurations, then when the base station instructs the UE to switch from m-TRP to single TRP operation via DCI, the base station would have to add one more TPMI bit to account for the increase from 3 bits to 4 bits resulting from the switch. Such an increase necessitate an increase of DCI overhead. To avoid the overhead increase, some implementations contemplate excluding the third example scenario from allowed SRS resource configurations.

A fourth example scenario assumes parameter codebookSubset is set to a value of “PartialAndNonCoherent,” ul-FullPowerTransmission is set to a value of “fullppowerMode1,” (L_{Smax}, L_{1,Mmax}, L_{2,Mmax})=(4, 2, 2), and (N_{1,ant}, N_{2,ant})=(4, 2). For m-TRP operation, as the first SRS resource set has L_{1,Mmax}=2 maximum transmission layers and N_{1,ant}=4 SRS ports, table 7.3.1.1.2-2A in FIG. 4E applies. From the two left columns of the table, the UE can determine that the TPMI corresponding to the first SRS resource set is indicated using 5 bits in DCI. As the second SRS resource set has L_{2,Mmax}=2 maximum transmission layers and N_{2,ant}=2 SRS ports, table 7.3.1.1.2-4A in FIG. 4F applies. From the table, the UE can determine that the TPMI corresponding to the second SRS resource set is indicated using 2 bits in DCI. The total number of bits for TPMI is thus 7 bits for m-TRP operation.

Continuing with the fourth example scenario, for single TRP operation, as the SRS resource set has L_{Smax}=4 maximum transmission layers, table 7.3.1.1.2-2B in FIG. 4G applies. From the left two columns of the table, the UE can determine that 6 DCI bits are needed for TPMI for single-TRP operation. Consistent with this determination, the UE and the base station can agree that the first 6 bits of the 7 TPMI bits are used as TPMI when the base station instructs the UE to switch from m-TRP to single-TRP operation.

A fifth example scenario assumes parameter codebookSubset is set to a value of “PartialAndNonCoherent,” ul-FullPowerTransmission is set to a value of “fullppowerMode1,” (L_{Smax}, L_{1,Mmax}, L_{2,Mmax})=(3, 1, 2), and (N_{1,ant}, N_{2,ant})=(4, 2). For m-TRP operation, as the first SRS resource set has L_{1,Mmax}=1 maximum transmission layer and N_{1,ant}=4 SRS ports, table 7.3.1.1.2-3A in FIG. 4H applies. From the two left columns of the table, the UE can determine that the TPMI corresponding to the first SRS resource set is indicated using 4 bits in DCI. As the second SRS resource set has L_{2,Mmax}=2 maximum transmission layers and N_{2,ant}=2 SRS ports, table 7.3.1.1.2-4A in FIG. 4F again applies. From the table, the UE can determine that the TPMI corresponding to the second SRS resource set is indicated using 2 bits in DCI. The total number of bits for TPMI is thus 6 bits for m-TRP operation.

Continuing with the fifth example scenario, for single TRP operation, as the SRS resource set has L_{Smax}=3 maximum transmission layers, table 7.3.1.1.2-2B in FIG. 4G again applies. From the left two columns of the table, the UE can determine that 6 DCI bits are needed for TPMI for single-TRP operation. Consistent with this determination, the UE and the base station can agree that all of the 6 TPMI bits for m-TRP operation are used as TPMI when the base station instructs the UE to switch from m-TRP to single-TRP operation.

From the above discussion, it can be seen that with the exclusion of certain scenarios, the base station does not need to introduce extra DCI bits for TPMI when instructing the UE to switch from m-TRP to single-TRP operation. Accordingly, implementations described above can advantageously support the switch between operations with minimal DCI overhead increase.

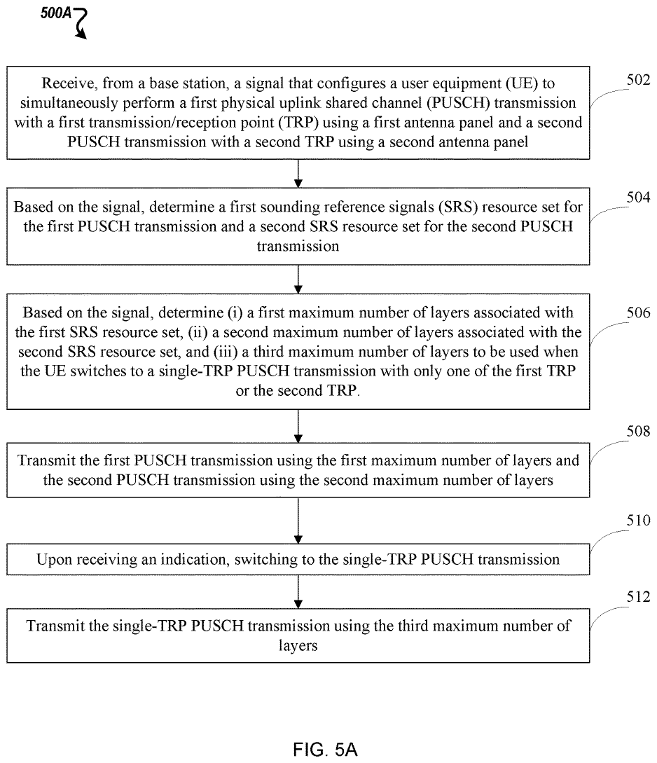

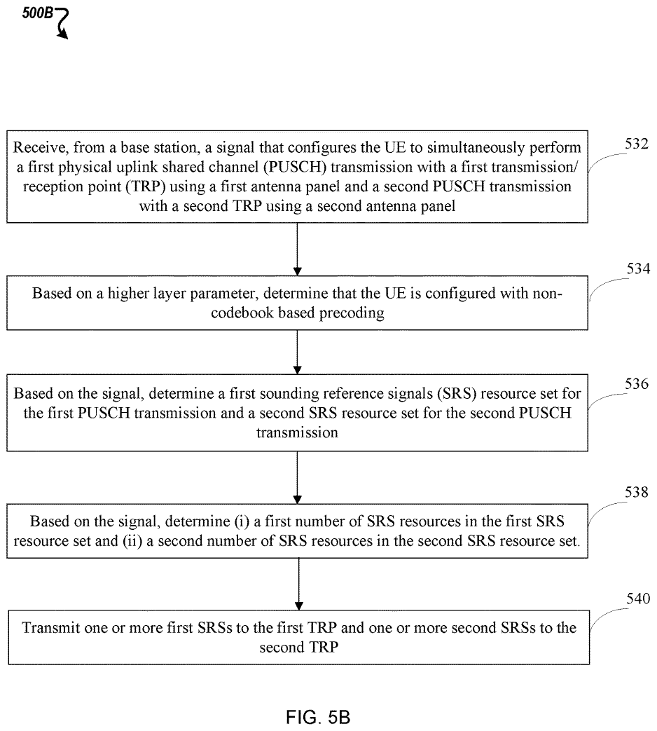

FIG. 5A illustrates a flowchart of an example method 500A, according to some implementations. For clarity of presentation, the description that follows generally describes method 500A in the context of the other figures in this description. For example, method 500A can be performed by UE 102 of FIG. 1 or UE 202 of FIG. 2. It will be understood that method 500A can be performed, for example, by any suitable system, environment, software, hardware, or a combination of systems, environments, software, and hardware, as appropriate. In some implementations, various steps of method 500A can be run in parallel, in combination, in loops, or in any order.

At 502, method 500A involves receiving, from a base station, a signal that configures the UE to simultaneously perform a first PUSCH transmission with a first TRP using a first antenna panel and a second PUSCH transmission with a second TRP using a second antenna panel. The base station can be similar to base station 104 of FIG. 1 or base station 204 of FIG. 2. The signal can include one or more configuration parameters transmitted at 212 of FIG. 2.

At 504, method 500A involves determining, based on the signal, a first SRS resource set for the first PUSCH transmission and a second SRS resource set for the second PUSCH transmission. The determination can be similar to at least a part of SRS resource configuration performed by UE 202 at 214 of FIG. 2.

At 506, method 500A involves determining, based on the signal, (i) a first maximum number of layers associated with the first SRS resource set, (ii) a second maximum number of layers associated with the second SRS resource set, (iii) a third maximum number of layers to be used when the UE switches to a single-TRP PUSCH transmission with only one of the first TRP or the second TRP, or any combination of the above. The first maximum number of layers, the second maximum number of layers, and the third maximum number of layers can be similar to, e.g., L_{1,Mmax}, L_{2,Mmax}, and L_{Smax}, respectively.

At 508, method 500A involves transmitting the first PUSCH transmission using the first maximum number of layers, the second PUSCH transmission using the second maximum number of layers, or any combination of the above.

At 510, method 500A may optionally involve, upon receiving an indication, switching to the single-TRP PUSCH transmission. The indication can be included in the DCI transmitted to the UE, similar to 218 of FIG. 2.

At 512, method 500A may optionally involve transmitting the single-TRP PUSCH transmission using the third maximum number of layers.

FIG. 5B illustrates a flowchart of an example method 500B, according to some implementations. For clarity of presentation, the description that follows generally describes method 500B in the context of the other figures in this description. For example, method 500B can be performed by UE 102 of FIG. 1 or UE 202 of FIG. 2. It will be understood that method 500B can be performed, for example, by any suitable system, environment, software, hardware, or a combination of systems, environments, software, and hardware, as appropriate. In some implementations, various steps of method 500B can be run in parallel, in combination, in loops, or in any order.

At 532, method 500B involves receiving, from a base station, a signal that configures the UE to simultaneously perform a first PUSCH transmission with a first TRP using a first antenna panel and a second PUSCH transmission with a second TRP using a second antenna panel. The base station can be similar to base station 104 of FIG. 1 or base station 204 of FIG. 2. The signal can include one or more configuration parameters transmitted at 212 of FIG. 2.

At 534, method 500B involves determining, based on a higher layer parameter, that the UE is configured with non-codebook based precoding. In some implementations, the higher layer parameter is txConfig that is transmitted at 212 of FIG. 2.

At 536, method 500B involves determining, based on the signal, a first SRS resource set for the first PUSCH transmission, a second SRS resource set for the second PUSCH transmission, or any combination of the above. The determination can be similar to at least a part of SRS resource configuration performed by UE 202 at 214 of FIG. 2.

At 538, method 500B involves determining, based on the signal, (i) a first number of SRS resources in the first SRS resource set, (ii) a second number of SRS resources in the second SRS resource set, or any combination of the above. The determination can also be similar to at least a part of SRS resource configuration performed by UE 202 at 214 of FIG. 2.

At 540, method 500B involves transmitting one or more first SRSs to the first TRP, one or more second SRSs to the second TRP, or any combination of the above. The transmission can be similar to the SRS transmission in 216 of FIG. 2.

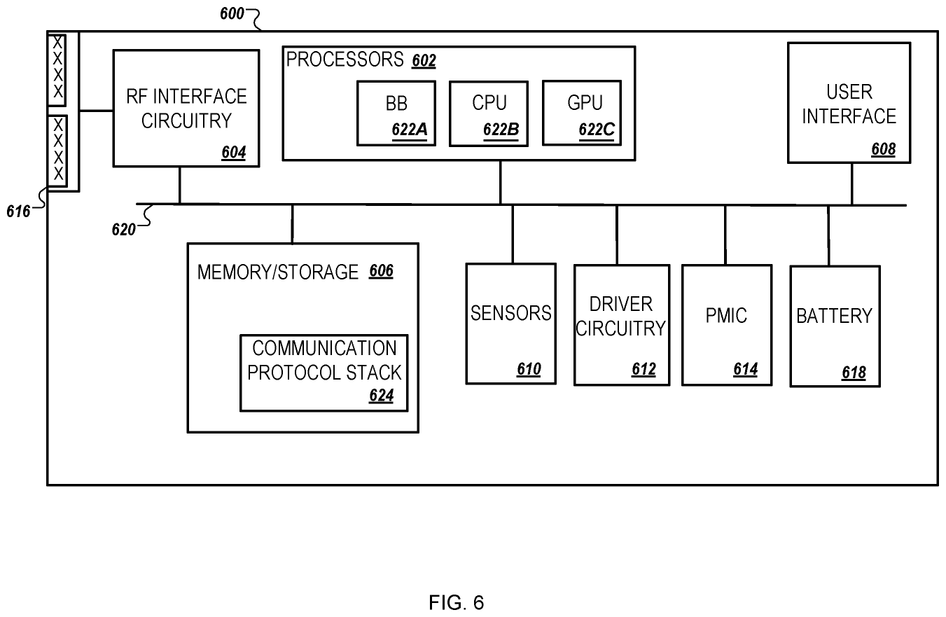

FIG. 6 illustrates a UE 600, according to some implementations. The UE 600 may be similar to and substantially interchangeable with UE 102 of FIG. 1 or UE 202 of FIG. 2.

The UE 600 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, one or more antenna(s) 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein, such as those of methods 500A or 500B.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 616. In various implementations, the RF interface circuitry 604 may be configured to transmit/receive signals in a manner compatible with NR access technologies.

The antenna(s) 616 may include one or more antenna elements to convert electrical signals into radio waves to travel through the air and to convert received radio waves into electrical signals. The antenna elements may be arranged into one or more antenna panels. The antenna(s) 616 may have antenna panels that are omnidirectional, directional, or a combination thereof to enable beamforming and multiple input, multiple output communications. The antenna(s) 616 may include microstrip antennas, printed antennas fabricated on the surface of one or more printed circuit boards, patch antennas, phased array antennas, etc. The antenna(s) 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensors 610 and control and allow access to sensors 610, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

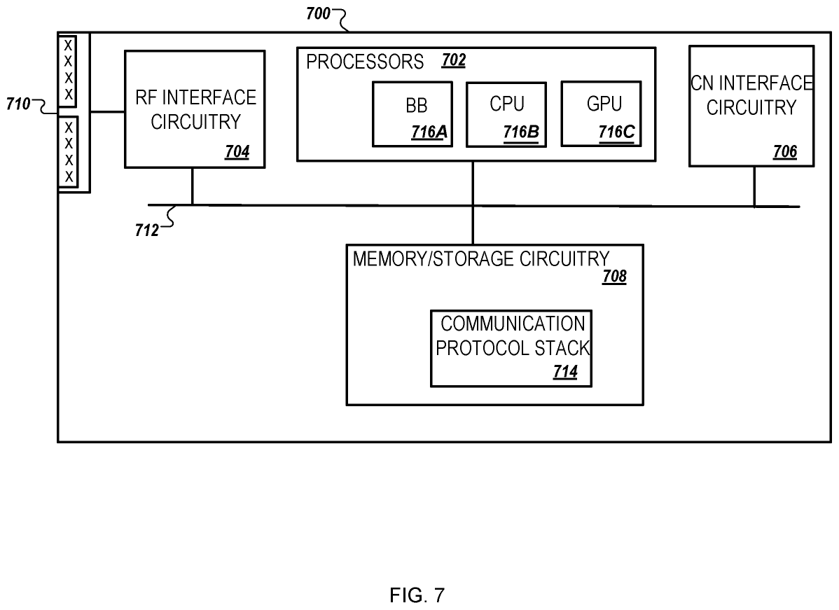

FIG. 7 illustrates an access node 700 (e.g., a base station or gNB), according to some implementations. The access node 700 may be similar to and substantially interchangeable with base station 104. The access node 700 may include processors 702, RF interface circuitry 704, core network (CN) interface circuitry 706, memory/storage circuitry 708, and antenna structure 710.

The components of the access node 700 may be coupled with various other components over one or more interconnects 712. The processors 702, RF interface circuitry 704, memory/storage circuitry 708 (including communication protocol stack 714), antenna(s) 710, and interconnects 712 may be similar to like-named elements shown and described with respect to FIG. 6. For example, the processors 702 may include processor circuitry such as, for example, baseband processor circuitry (BB) 716A, central processor unit circuitry (CPU) 716B, and graphics processor unit circuitry (GPU) 716C. The processors 702 may be configured to perform operations described herein, such as determining UE configuration parameters and controlling transmission of DCI to the UE.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes one or more processors including circuitry that executes instructions to cause a user equipment (UE) to perform operations including: receiving, from a base station, a signal that configures the UE to simultaneously perform a first physical uplink shared channel (PUSCH) transmission with a first transmission/reception point (TRP) using a first antenna panel and a second PUSCH transmission with a second TRP using a second antenna panel; based on a higher layer parameter, determining that the UE is configured with non-codebook based precoding; based on the signal, determining a first sounding reference signal (SRS) resource set for the first PUSCH transmission and a second SRS resource set for the second PUSCH transmission; based on the signal, determining (i) a first number of SRS resources in the first SRS resource set and (ii) a second number of SRS resources in the second SRS resource set; and causing the UE to transmit one or more first SRSs on the first number of SRS resources to the first TRP and one or more second SRSs on the second number of SRS resources to the second TRP.

Example 2 includes the one or more processors of example 1, wherein the first number of SRS resources equals the second number of SRS resources.

Example 3 includes the one or more processors of example 1 or 2, the operations further including: determining a first number of SRS ports associated with the SRS resources in first SRS resource set; and determining a second number of SRS ports associated with the SRS resources in second SRS resource set.

Example 4 includes the one or more processors of example 3, wherein the first number of SRS ports is different from the second number of SRS ports.

Example 5 includes the one or more processors of example 3 or 4, the operations further including: determining a first number of bits of a transmit precoding matrix indicator (TPMI) for the first PUSCH transmission; determining a second number of bits of a TPMI for the second PUSCH transmission; and determining a third number of bits of a TPMI to be used when the UE switches to a PUSCH transmission with only one of the first TRP or the second TRP.

Example 6 includes the one or more processors of example 5, wherein the first number of bits is determined based on the first number of SRS ports and a first maximum number of layers associated with the first SRS resource set, and wherein the second number of bits is determined based on the second number of SRS ports and a second maximum number of layers associated with the second SRS resource set.

Example 7 includes the one or more processors of example 5 or 6, wherein the third number of bits is determined based on a third maximum number of layers to be used when the UE switches to the PUSCH transmission with the only one of the first TRP or the second TRP.

Example 8 includes the one or more processors of any of examples 5 to 7, wherein the first number of bits, the second number of bits, and the third number of bits are determined based on one or more higher layer parameters.

Example 9 includes the one or more processors of any of examples 1 to 8, wherein the UE performs the first PUSCH transmission and the second PUSCH transmission using a space division multiplexing (SDM) scheme.

Example 10 includes a base station in communication with a user equipment (UE), the base station including one or more processors coupled to a transceiver, wherein: the one or more processors are configured to determine one or more parameters that configure the UE to simultaneously perform a first physical uplink shared channel (PUSCH) transmission with a first transmission/reception point (TRP) using a first antenna panel and a second PUSCH transmission with a second TRP using a second antenna, the one or more parameters indicating a first sounding reference signal (SRS) resource set for the first PUSCH transmission and a second SRS resource set for the second PUSCH transmission, the one or more processors are configured to determine a higher layer parameter, the transceiver is configured to transmit a signal with the one or more parameters to the UE, wherein the signal includes information for the UE to determine (i) a first number of SRS resources in the first SRS resource set and (ii) a second number of SRS resources in the second SRS resource set, and the transceiver is configured to transmit the higher layer parameter to configure the UE with non-codebook based precoding.

Example 11 includes the base station of example 10, wherein the first number of SRS resources equals the second number of SRS resources.

Example 12 includes the base station of example 10 or 11, wherein the signal further includes information for the UE to determine a first number of SRS ports associated with the SRS resources in first SRS resource set and a second number of SRS ports associated with the SRS resources in second SRS resource set.

Example 13 includes the base station of example 12, wherein the first number of SRS ports is different from the second number of SRS ports.

Example 14 includes the base station of example 12 or 13, wherein: the one or more processors are configured to determine at least one of (iii) a first transmit precoding matrix indicator (TPMI) for the first PUSCH transmission, (iv) a second TPMI for the second PUSCH transmission, or (v) a third TPMI to be used when the UE switches to a PUSCH transmission with only one of the first TRP or the second TRP, and the transceiver is configured to transmit downlink control information (DCI) to the UE, the DCI including the at least one of the first TMPI, the second TPMI, or the third TPMI.

Example 15 includes a method including: receiving, from a base station, a signal that configures a user equipment (UE) to simultaneously perform a first physical uplink shared channel (PUSCH) transmission with a first transmission/reception point (TRP) using a first antenna panel and a second PUSCH transmission with a second TRP using a second antenna panel; based on a higher layer parameter, determining that the UE is configured with non-codebook based precoding; based on the signal, determining a first sounding reference signal (SRS) resource set for the first PUSCH transmission and a second SRS resource set for the second PUSCH transmission; and based on the signal, determining (i) a first number of SRS resources in the first SRS resource set and (ii) a second number of SRS resources in the second SRS resource set; and transmitting one or more first SRSs on the first number of SRS resources to the first TRP and one or more second SRSs on the second number of SRS resources to the second TRP.

Example 16 includes the method of example 15, wherein the first number of SRS resources equals the second number of SRS resources.

Example 17 includes the method of example 15 or 16, further including: determining a first number of SRS ports associated with the SRS resources in first SRS resource set; and determining a second number of SRS ports associated with the SRS resources in second SRS resource set.

Example 18 includes the method of example 17, wherein the first number of SRS ports is different from the second number of SRS ports.

Example 19 includes the method of example 17 or 18, the operations further including: determining a first number of bits of a transmit precoding matrix indicator (TPMI) for the first PUSCH transmission; determining a second number of bits of a TPMI for the second PUSCH transmission; and determining a third number of bits of a TPMI to be used when the UE switches to a PUSCH transmission with only one of the first TRP or the second TRP.

Example 20 includes the method of any of examples 15 to 19, wherein the UE performs the first PUSCH transmission and the second PUSCH transmission using a space division multiplexing (SDM) scheme.

Example 21 may include one or more non-transitory computer-readable media including instructions to cause an electronic device, upon execution of the instructions by one or more processors of the electronic device, to perform one or more elements of a method described in or related to any of examples 1-20, or any other method or process described herein.

Example 22 may include an apparatus including logic, modules, or circuitry to perform one or more elements of a method described in or related to any of examples 1-20, or any other method or process described herein.

Example 23 may include a method, technique, or process as described in or related to any of examples 1-20, or portions or parts thereof.

Example 24 may include an apparatus including: one or more processors and one or more computer-readable media including instructions that, when executed by the one or more processors, cause the one or more processors to perform the method, techniques, or process as described in or related to any of examples 1-20, or portions thereof.

Example 25 may include a signal as described in or related to any of examples 1-20, or portions or parts thereof.

Example 26 may include a datagram, information element, packet, frame, segment, PDU, or message as described in or related to any of examples 1-20, or portions or parts thereof, or otherwise described in the present disclosure.

Example 27 may include a signal encoded with data as described in or related to any of examples 1-20, or portions or parts thereof, or otherwise described in the present disclosure.

Example 28 may include a signal encoded with a datagram, IE, packet, frame, segment, PDU, or message as described in or related to any of examples 1-20, or portions or parts thereof, or otherwise described in the present disclosure.

Example 29 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 30 may include a computer program including instructions, wherein execution of the program by a processing element is to cause the processing element to carry out the method, techniques, or process as described in or related to any of examples 1-20, or portions thereof. The operations or actions performed by the instructions executed by the processing element can include the methods of any one of examples 1-20.

Example 31 may include a signal in a wireless network as shown and described herein.

Example 32 may include a method of communicating in a wireless network as shown and described herein.

Example 33 may include a system for providing wireless communication as shown and described herein. The operations or actions performed by the system can include the methods of any one of examples 1-20.

Example 34 may include a device for providing wireless communication as shown and described herein. The operations or actions performed by the device can include the methods of any one of examples 1-20.

The previously-described examples 1-20 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-20.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors configured, when executing instructions stored in memory, to perform operations comprising:
receiving an indication to simultaneously perform a first physical uplink shared channel (PUSCH) transmission with a first transmission/reception point (TRP) using a first antenna panel and a second PUSCH transmission with a second TRP using a second antenna panel;
receiving a higher layer parameter comprising a codebook based precoding configuration;
based on the indication, determining a first sounding reference signal (SRS) resource set for the first PUSCH transmission and a second SRS resource set for the second PUSCH transmission;
based on the indication, determining (i) a first number of SRS resources in the first SRS resource set and (ii) a second number of SRS resources in the second SRS resource set; and
causing transmission of one or more first SRSs on the first number of SRS resources to the first TRP and one or more second SRSs on the second number of SRS resources to the second TRP.

2. The one or more processors of claim 1, wherein the first number of SRS resources equals the second number of SRS resources.

3. The one or more processors of claim 1, the operations further comprising:
determining a first number of SRS ports associated with the SRS resources in first SRS resource set; and
determining a second number of SRS ports associated with the SRS resources in second SRS resource set.

4. The one or more processors of claim 3, wherein the first number of SRS ports is different from the second number of SRS ports.

5. The one or more processors of claim 3, the operations further comprising:
determining a first number of bits of a transmit precoding matrix indicator (TPMI) for the first PUSCH transmission;
determining a second number of bits of a TPMI for the second PUSCH transmission; and
determining a third number of bits of a TPMI to be used when switched to a PUSCH transmission with only one of the first TRP or the second TRP.

6. The one or more processors of claim 5,
wherein the first number of bits is determined based on the first number of SRS ports and a first maximum number of layers associated with the first SRS resource set, and
wherein the second number of bits is determined based on the second number of SRS ports and a second maximum number of layers associated with the second SRS resource set.

7. The one or more processors of claim 5, wherein the third number of bits is determined based on a third maximum number of layers to be used when switched to the PUSCH transmission with the only one of the first TRP or the second TRP.

8. The one or more processors of claim 5, wherein the first number of bits, the second number of bits, and the third number of bits are determined based on one or more higher layer parameters.

9. The one or more processors of claim 1, wherein the first PUSCH transmission and the second PUSCH transmission are performed using a space division multiplexing (SDM) scheme.

10. A method, comprising:
determining one or more parameters for configuring a user equipment (UE) to simultaneously perform a first physical uplink shared channel (PUSCH) transmission with a first transmission/reception point (TRP) using a first antenna panel and a second PUSCH transmission with a second TRP using a second antenna, the one or more parameters indicating a first sounding reference signal (SRS) resource set for the first PUSCH transmission and a second SRS resource set for the second PUSCH transmission,
determining a higher layer parameter,
transmitting an indication of the one or more parameters to the UE, wherein the signal comprises information for the UE to determine (i) a first number of SRS resources in the first SRS resource set and (ii) a second number of SRS resources in the second SRS resource set, and
transmitting the higher layer parameter to configure the UE with codebook based precoding.

11. The method of claim 10, wherein the first number of SRS resources equals the second number of SRS resources.

12. The method of claim 10, wherein the indication further comprises information for the UE to determine a first number of SRS ports associated with the SRS resources in first SRS resource set and a second number of SRS ports associated with the SRS resources in second SRS resource set.

13. The method of claim 12, wherein the first number of SRS ports is different from the second number of SRS ports.

14. The method of claim 12, further comprising:
determining at least one of (iii) a first transmit precoding matrix indicator (TPMI) for the first PUSCH transmission, (iv) a second TPMI for the second PUSCH transmission, or (v) a third TPMI to be used when the UE switches to a PUSCH transmission with only one of the first TRP or the second TRP, and
transmitting downlink control information (DCI) to the UE, the DCI comprising the at least one of the first TMPI, the second TPMI, or the third TPMI.

15. A method, comprising:
receiving an indication to simultaneously perform a first physical uplink shared channel (PUSCH) transmission with a first transmission/reception point (TRP) using a first antenna panel and a second PUSCH transmission with a second TRP using a second antenna panel;
receiving a higher layer parameter comprising a codebook based precoding configuration;
based on the indication, determining a first sounding reference signal (SRS) resource set for the first PUSCH transmission and a second SRS resource set for the second PUSCH transmission; and
based on the indication, determining (i) a first number of SRS resources in the first SRS resource set and (ii) a second number of SRS resources in the second SRS resource set; and
causing transmission of one or more first SRSs on the first number of SRS resources to the first TRP and one or more second SRSs on the second number of SRS resources to the second TRP.

16. The method of claim 15, wherein the first number of SRS resources equals the second number of SRS resources.

17. The method of claim 15, further comprising:
determining a first number of SRS ports associated with the SRS resources in first SRS resource set; and
determining a second number of SRS ports associated with the SRS resources in second SRS resource set.

18. The method of claim 17, wherein the first number of SRS ports is different from the second number of SRS ports.

19. The method of claim 17, further comprising:
determining a first number of bits of a transmit precoding matrix indicator (TPMI) for the first PUSCH transmission;
determining a second number of bits of a TPMI for the second PUSCH transmission; and
determining a third number of bits of a TPMI to be used when switched to a PUSCH transmission with only one of the first TRP or the second TRP.

20. The method of claim 15, wherein the method is performed by a user equipment (UE) or one or more baseband processors.
